(19) United States
(12) Patent Application Publication
(10) Pub. No.: US 2005/0039101 A1
(43) Pub. Date: Feb. 17, 2005

(54) Method and system of retransmission

(76) Inventor: Johan Torsner, Finland (SE)

Correspondence Address: ERICSSON INC., 6300 LEGACY DRIVE, M/S EVR C11, PLANO, TX, 75024, US

(21) Appl. No.: 10/496,243

(22) PCT Filed: Nov. 27, 2002
(86) PCT No.: PCT/SE02/02186

(30) Foreign Application Priority Data
Nov. 28, 2001 (SE) 0104022-9

(51) Int. Cl. H04L 1/18; G08C 25/02

(52) U.S. Cl. 714/748

(57) ABSTRACT

The present invention relates to a method and system of transmissions and retransmissions of packet data in a communications system, introducing concatenated ARQ loops between a radio network controller and a user equipment. Particularly, the invention relates to a Universal Mobile Telecommunications System, UMTS, or WCDMA system.

### TECHNICAL FIELD OF THE INVENTION

The present invention relates to transmissions and retransmissions of packet data in a communications system. Especially, it relates to transmissions of packet data in a cellular mobile radio system, particularly a Universal Mobile Telecommunications System, UMTS, or WCDMA system.

### BACKGROUND AND DESCRIPTION OF RELATED ART

Retransmission of data to or from a mobile station, MS, or user equipment, UE, is previously known. It is also known to use medium access control and radio link control layers of a UMTS protocol structure in acknowledged mode for dedicated channels.

In acknowledged mode of UMTS, retransmissions are undertaken in case of detected transmission errors not recovered by forward error control. This is also called automatic repeat request, ARQ. With ARQ, retransmissions can be undertaken unless a transmitted message is (positively) acknowledged within a predetermined time frame, or if it is negatively acknowledged.

Within this patent application, a radio network controller, RNC, is understood as a network element including a radio resource controller. The RNC is connected to a fixed network. Node B is a logical node responsible for radio transmission/reception in one or more cells to/from a User Equipment. A base station, BS, is a physical entity representing Node B.

With reference to FIG. 1, base stations <<BS 1>> and <<BS 2>> are physical entities representing Nodes B <<Node B 1>> and <<Node B 2>> respectively. <<Node B 1>> and <<Node B 2>> terminate the air interface, called Uu interface within UMTS, between UE and respective Node B towards the radio network controller <<RNC>>. A radio network controller <<RNC>> controlling the respective Nodes B <<Node B 1>>, <<Node B 2>> is connected to each of them over an Iub interface.

Medium access control, MAC, and radio link control, RLC, are used within radio communications systems like General Packet Radio Services, GPRS, and UMTS.

U.S. Pat. No. 5,570,367 discloses a wireless communications system arranged to transmit acknowledgement and request for retransmission messages. Data received in a microcell from an end user device is forwarded to a cell site. Data received by the cell site is transmitted to a cellular switch. A base station sends a poll message to the end user device, inquiring for the status of unacknowledged messages previously transmitted from the base station.

Also, a base station transmitter window is defined. A lower end pointer identifies a lowest numbered packet transmitted to and acknowledged by the base station. The upper end pointer identifies the highest numbered packet transmitted by the base station. Consequently, the window represents packets transmitted by the base station and unacknowledged by the end user device.

U.S. Pat. No. 6,118,765 also recognizes an acknowledge scheme of a discriminator using a sliding window. The discriminator passes valid packets for forwarding.

International Patent Application WO0021231 relates to a system for communicating data packets over a packet switched network where a buffering network entity acts as end-receiver of data packets transmitted from a sending host.

3^{rd} Generation Partnership Project (3GPP): Technical Specification Group Radio Access Network, Physical Layer Procedures, 3G TS 25.301 v3.6.0, France, September 2000, specifies in chapter 5 Radio Interface Protocol Architecture of a UMTS system. There are three protocol layers:
physical layer, layer 1 or L1,
data link layer, layer 2 or L2, and
network layer, layer 3 or L3.

Layer 2, L2, and layer 3, L3 are divided into Control and User Planes. Layer 2 consists of two sub-layers, RLC and MAC, for the Control Plane and four sub-layers, BMC, PDCP, RLC and MAC, for the User Plane. The acronyms BMC, PDCP, RLC and MAC denote Broadcast/Multicast Control, Packet Data Convergence Protocol, Radio Link Control and Medium Access Control respectively.

FIG. 2 illustrates a simplified UMTS layers 1 and 2 protocol structure for a Uu Stratum, UuS, or Radio Stratum, between a user equipment UE and a Universal Terrestrial Radio Access Network, UTRAN.

Radio Access Bearers, RABs, are associated with the application for transportation of services between core network, CN, and user equipment, UE, through a radio access network. Each RAB is associated with quality attributes such as service class, guaranteed bit rate, transfer delay, residual BER, and traffic handling priority. An RAB may be assigned one or more Radio Bearers, RBs, being responsible for the transportation between UTRAN and UE. For each mobile station there may be one or several RBs representing a radio link comprising one or more channels between UE and UTRAN. Data flows (in the form of segments) of the RBs are passed to respective Radio Link Control, RLC, entities which amongst other tasks buffer the received data segments. There is one RLC entity for each RB. In the RLC layer, RBs are mapped onto respective logical channels. A Medium Access Control, MAC, entity receives data transmitted in the logical channels and further maps logical channels onto a set of transport channels. In accordance with subsection 5.3.1.2 of the 3GPP technical specification MAC should support service multiplexing e.g. for RLC services to be mapped on the same transport channel. In this case identification of multiplexing is contained in the MAC protocol control information.

Transport channels are finally mapped to a single physical channel which has a total bandwidth allocated to it by the network. In frequency division duplex mode, a physical channel is defined by code, frequency and, in the uplink, relative phase (I/Q). In time division duplex mode a physical channel is defined by code, frequency, and time-slot. As further described in subsection 5.2.2 of the 3GPP technical specification the L1 layer is responsible for error detection on transport channels and indication to higher layer, FEC encoding/decoding and interleaving/deinterleaving of transport channels.

PDCP provides mapping between Network PDUs (Protocol Data Units) of a network protocol, e.g. the Internet protocol, to an RLC entity. PDCP compresses and decompresses redundant Network PDU control information (header compression and decompression).

For transmissions on point-to-multipoint logical channels, BMC stores at UTRAN-side Broadcast Messages received from an RNC, calculates the required transmission rate and requests for the appropriate channel resources. It receives scheduling information from the RNC, and generates schedule messages. For transmission the messages are mapped on a point-to-multipoint logical channel. At the UE side, BMC evaluates the schedule messages and deliver Broadcast Messages to upper layer in the UE.

3G TS 25.301 also describes protocol termination, i.e. in which node of the UTRAN the radio interface protocols are terminated, or equivalently, where within UTRAN the respective protocol services are accessible.

In UMTS, the RLC protocol is terminated in a serving RNC, SRNC, responsible for interconnecting the radio access network of UMTS to a core network. In relation to a Node B, an RNC controlling it is a Controlling RNC. The Serving RNC and Controlling RNC can be separate or co-incident. In case of separate RNCs they communicate over an Iur interface, otherwise they communicate locally. An RNC comprises an RLC entity including an L2/RLC protocol layer <<L2/RLC>> at UTRAN side in FIG. 2. There are two MAC-entities, MAC-d and MAC-c/-sh, routing dedicated channels over common or shared channels. MAC-d resides in the Serving RNC and MAC-c/-sh in the Controlling RNC. The routing comprises buffering of data in the MAC-entities MAC-d and MAC-c/-sh, to accommodate for the unsynchronized data flows into and out of MAC-d and MAC-c/-sh. The two MAC-entities MAC-d and MAC-c/-sh are responsible for the L2/MAC protocol layer functionality at UTRAN side according to FIG. 2.

3^{rd} Generation Partnership Project (3GPP): Technical Specification Group Radio Access Network, RLC Protocol Specification, 3GPP TS 25.322 v3.5.0, France, December 2000, specifies the RLC protocol. The RLC layer provides three services to higher layers:
transparent data transfer service,
unacknowledged data transfer service, and
acknowledged data transfer service.

In subsection 4.2.1.3 an acknowledged mode entity, AM-entity, is described (see FIG. 4.4 of the 3GPP Technical Specification). In acknowledged mode automatic repeat request, ARQ, is used. The RLC sub-layer provides ARQ functionality closely coupled with the radio transmission technique used. The 3GPP technical specification also reveals various triggers for a status report to be transmitted. The receiver shall always send a status report, if it receives a polling request. There are also three status report triggers, which can be configured
1. Missing PU(s) Detected,
2. Timer Initiated Status Report, and
3. Estimated PDU Counter.

For trigger 1, the receiver shall trigger transmission of a status report to the sender if a payload unit, PU, is detected to be missing. (One PU is included in one RLC PDU.) With trigger 2, a receiver triggers transmission of a status report periodically according to a timer. Finally, trigger 3 relates in short to a timer corresponding to an estimated number of received PUs before the requested PUs are received. The 3GPP Technical Specification specifies a status PDU used to report the status between two RLC AM (‘Acknowledged Mode’) entities.

3GPP TS 25.322 specifies RLC state variables at the transmitter and at the receiver. At the transmitter side some of these are
VT(S) Send state variable,
VT(A) Acknowledge state variable,
VT(MS) Maximum Send state variable, and
VT(WS) Transmitter window size state variable.

VT(S) is the sequence number of the next PU to be transmitted for the first time (i.e. excluding retransmission). VT(A) is the sequence number of the next in-sequence PU expected to be acknowledged, which forms the lower edge of the window of acceptable acknowledgements. VT(MS) is the sequence number of the first PU not allowed by the receiver [i.e. the receiver will allow up to VT(MS)−1]. This value represents the upper edge of the transmit window. VT(WS) is the size that shall be used for the transmitter window. Consequently, VT(WS) relates to VT(A) and VT(MS) according to
VT(WS)=VT(MS)−VT(A).
One of the state variables at the receiver side is
VR(R) Receive state variable.
   VR(R) is the sequence number of the next in-sequence PU expected to be received. It is set equal to SNmax+1 upon receipt of the next in-sequence PU, where SNmax is the sequence number of the highest received in-sequence PU.

None of the cited documents above discloses a method and system of transmissions and retransmissions of packet data, splitting a connection involving multiple ARQ loops and transferring transmitter state variables between the loops.

### SUMMARY OF THE INVENTION

In a radio communications system operating in acknowledged mode, according to prior art, data is buffered in a Radio Network Controller. ARQ loops introduces delay and round-trip time latency. I.e., the time for an application to perceive a response to transmitted data or undertaken action from the opposite end is not immediate. ARQ loops will also require buffering.

Higher layer applications can be, e.g., applications on the Internet. Most applications on the Internet use protocols, such as TCP (Transport Control Protocol), that control the transmission rate, based on link quality in terms of packet loss and delay characteristics. Consequently, besides the negative effect of retransmission delays as such on perceived quality, substantial queuing delay can also lead to secondary effects further reducing quality of service.

A proper introduction of a hybrid ARQ protocol in Node B, according to the invention, would render at least some of the required acknowledgements of prior art superfluous and improve system performance. Elimination of an existing ARQ loop raises requirements on proper handling of acknowledgements and status reports, between nodes involved, particularly in connection with handover involving more than one Node B.

Consequently, it is an object of this invention to eliminate or reduce delay and latency as perceived by a user.

A related object is to reduce delay and latency as perceived by a flow control algorithm in a WCDMA (Wideband Code Division Multiple Access) system.

A further object is to provide a method and system for providing an ARQ loop with handover status information from another ARQ loop.

Finally, it is an object to fast and efficiently provide a Node B with queuing data for in-sequence delivery of RLC PDUs to a user equipment at handover.

These objects are met by the invention, which is particularly well suited for a Universal Mobile Telecommunications System, UMTS, splitting an ARQ loop into two or more single loops and taking appropriate measures, explained in detail below, for queue updating at handover.

Preferred embodiments of the invention, by way of examples, are described with reference to the accompanying drawings below.

### BRIEF DESCRIPTION OF THE DRAWINGS

FIG. 1 shows communication, according to the invention, between a UE and a base station involved in a connection between an RNC and the UE.

FIG. 2 displays a layered protocol structure, according to prior art, in a radio communications system.

FIG. 3 shows a preferred layered protocol structure, a protocol stack, according to the invention.

FIG. 4 shows data units and transport blocks of a preferred protocol stack, according to the invention.

FIG. 5 schematically illustrate status report generation and transmissions, according to the invention.

FIG. 6 illustrates a communications system with ARQ functionality located to RNC, according to the invention.

FIG. 7 illustrates an alternative exemplary communications system with ARQ functionality located to RNC, according to the invention.

FIG. 8 schematically illustrates a flowchart of a first embodiment according to the invention.

FIG. 9 schematically depicts a flowchart of a second embodiment according to the invention.

FIG. 10 shows a block diagram including elements of the first and second embodiments.

### DESCRIPTION OF PREFERRED EMBODIMENTS

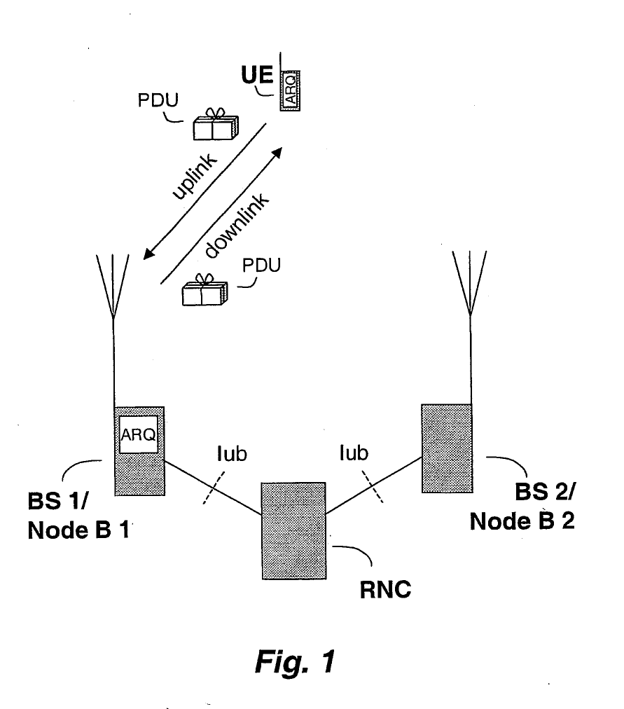

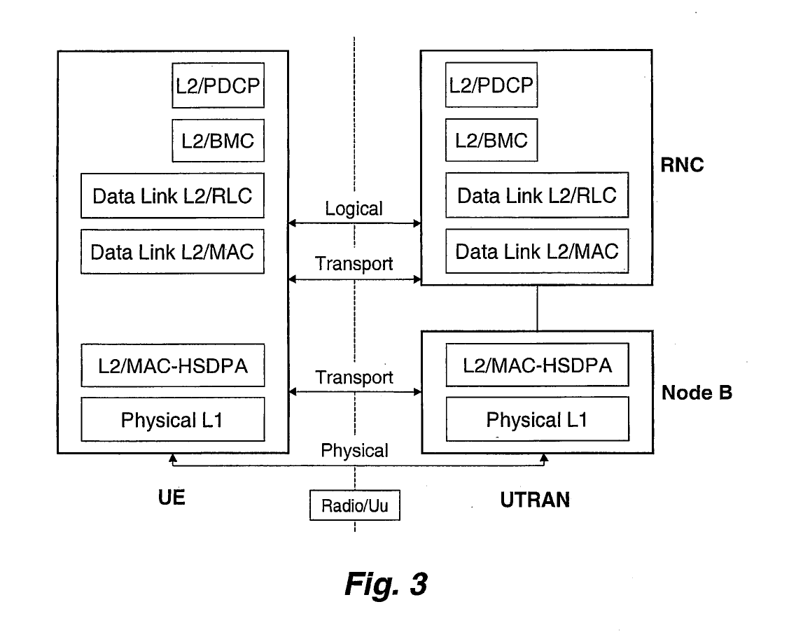

FIG. 3 shows a preferred layered protocol structure, a protocol stack, according to the invention. The L2 MAC layer of FIG. 1 has been extended and divided into two sub-layers, an L2 MAC sub-layer and a MAC-HSDPA sub-layer. Essentially the L2 MAC sub-layer corresponds to the prior art L2 MAC sub-layer of FIG. 1. The MAC-HSDPA plus the MAC layer could be regarded as one single MAC layer extended to also include hybrid ARQ functionality. However, for reasons of explanation they are preferably regarded as separate sub-layers. Further, on the network side, considering them as separate protocol sub-layers physically better corresponds to the physical entities where they reside. As illustrated in FIG. 3 on the UTRAN-side (or network side) L2 MAC sub-layer is preferably located in RNC, whereas L2 MAC-HSDPA sub-layer is located in Node B. As the hybrid ARQ protocol combines successively received retransmissions it is a great advantage to have this protocol close to the physical layer and, particularly, in Node B. Among the advantages achieved thereby, e.g., the round-trip delay is reduced as compared to a location in RNC. Within this patent application the protocol layers, except for L2 MAC and L2 MAC-HSDPA as just explained, correspond to those of FIG. 1.

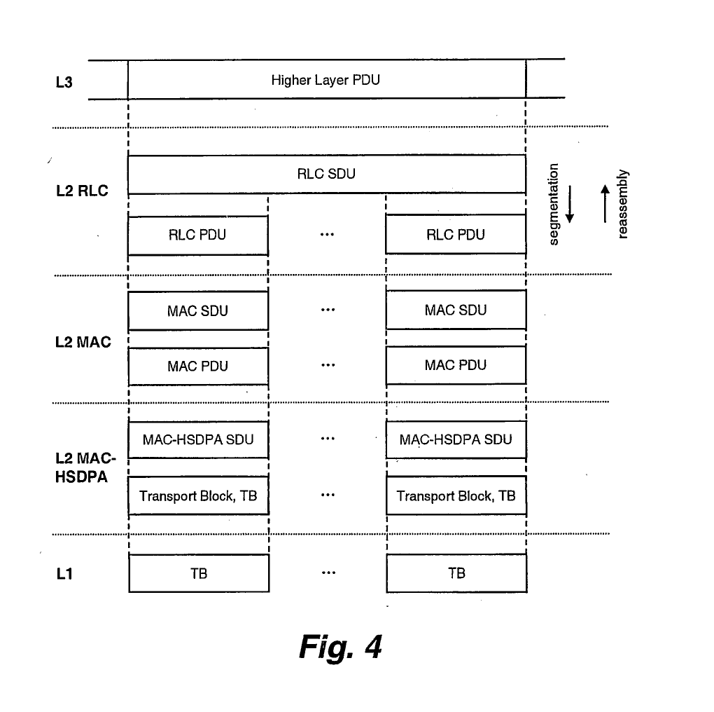

FIG. 4 shows data units and transport blocks of a preferred protocol stack, according to the invention. Packet switched data is transmitted in protocol data units, PDUs, in both directions. Each PDU is transported on a transport channel in at least one transport block, TB. Preferably there is one TB for each PDU. As described above, transmission errors on the transport channel are corrected and detected by layer L1. Each transport block, TB, can be provided an individual CRC error-detecting checksum prior to transmission on the physical channel. However, preferably a transmission unit, carrying one or more TBs, is provided only one CRC error-detecting checksum. If a transmission unit is detected to be in error on the receiving side, this is reported to the L2 MAC layer.

L2 MAC layer can request retransmission of transmission units received in error. Transmission units, detected to be in error, still carry information that should not be wasted. Preferably hybrid ARQ, utilizing information available from earlier transmission(s) of a transmission unit by proper combining with the latest retransmission, is used prior to an L2 MAC layer request for retransmission.

At the receiving end, error detection is also performed by layer L2 RLC. If an RLC protocol data unit, PDU, is received in error or the PDU is missing, it will be requested for retransmission at a point in time when a status report is established by the RLC layer. RLC PDUs are transferred to/from the MAC layer SDUs. The MAC SDU possibly includes a header not included in the RLC PDU. As explained in relation to FIG. 3, according to the invention there are preferably two MAC sub-layers, an L2 MAC sub-layer and an L2 MAC-HSDPA sub-layer. In a preferred embodiment of the invention, the L2 MAC sub-layer is located in RNC and the L2 MAC-HSDPA sub-layer is located in Node B. As previously described, the RLC PDUs are transferred in transport blocks, TBs, on the physical channel. The L2 MAC-HSDPA layer transfers TBs to the L1 physical layer. In the reverse direction the L2 MAC-HSDPA layer transfers TBs, possibly after combining of multiple transmissions of the respective TBs, indicated to be error-free to the L2 MAC layer. TBs not indicated to be error-free are requested for retransmission.

A network layer PDU or L3 PDU can comprise several RLC PDUS. RLC PDUs are reassembled into RLC service data units, RLC SDUs, prior to delivery to higher layer PDU. The L3 protocol can be, e.g., the Internet Protocol, IP. Upon reception from L3, RLC SDUs are segmented into RLC PDUs.

In an evolved WCDMA system, a high-speed downlink packet access channel, HSDPA channel, is a channel with similarities to a DSCH. However, it is based on a novel transport channel type. In the sequel, this is referred to as a High-Speed Downlink Shared CHannel, HS-DSCH. An HS-DSCH supports many features not supported by DSCH, but also inherits some of the characteristics of a DSCH. There are several important features of an HS-DSCH. A sample of features is:
High data rates with peak data rates up to tens of Mbit/s.
Data is transmitted to multiple users on a shared channel by means of time-division multiplex, TDM, or code-division multiplex, CDM.
Higher-order modulation.
Modulation adaptive to radio channel conditions.
Fast retransmission with soft combining of retransmitted data at UE, also referred to as Fast Hybrid ARQ or Fast HARQ.
Low air-interface delay, with maximum round-trip delay down to some ten milliseconds.

As an alternative to introducing the MAC-HSDPA sub-layer in Node B, the RLC protocol could reside in Node B. However, for reasons of compatibility RLC is in charge of ciphering and in-order delivery, preferably located in RNC. With RLC sub-layer residing in RNC, reliable packet delivery will be insured between Node B and RNC.

According to preferred embodiments of the invention, an L2 MAC-HSDPA sub-layer is responsible for Fast Hybrid ARQ.

One reason for terminating the Fast Hybrid ARQ in Node B is the reduction of round-trip delay as compared to terminating it in RNC. Another reason is that Node B is capable of using soft combining of multiply transmitted data packets, whereas RNC generally only receives hard-quantized bits.

L2 RLC sub-layer requires status reports acknowledging packet data units previously transferred from the L2 RLC layer, e.g. to advance the sliding transmitter window of the L2 RLC protocol. When, e.g., a poll timer times out it consequently transfers an inquiry for a status report. This inquiry is destined for the UE, in accordance with prior art. However, such an inquiry would load the scarce resource of the radio interface between Node B and UE. Further, terminating the Fast Hybrid ARQ in Node B, during stable operating conditions this node will be currently informed of the receive status of the UE in accordance with the Fast Hybrid ARQ scheme, possibly with a short delay for the most recent update of UE.

According to a preferred embodiment of the invention the Hybrid ARQ protocol entity at UTRAN-side generates status reports to the RNC-RLC. Status reports can be generated either upon request of the RNC-RLC (polling) or as conditionally triggered locally. In case of the latter, the triggers described in prior art and referred to on page 6 apply. Another trigger to be included is the number of PDUs received by Node B from RNC. When a predefined number of PDUs have been received by Node B, a status report is established in the Hybrid ARQ protocol entity, and transmitted to RNC.

Correspondingly, when Node B deals with status report establishment, the status report triggering in the UE can be relieved, in order not to load the scarce communication link resource between Node B and UE. With reference to trigger 1 on page 6, the triggering of UE can be avoided if Node B detects the missing PU in due time for delivery to UE prior to a point in time when it would otherwise have been detected or otherwise initiated establishment and transmission of a status report from UE. Triggers 2 and 3 depend on a preset time interval or number of PDUs. By extending the parameters appropriately, the number of status reports per unit time initiated in UE by these triggers can be reduced to a sufficiently small number, not loading the scarce communication link resource between UE and Node B more than necessary.

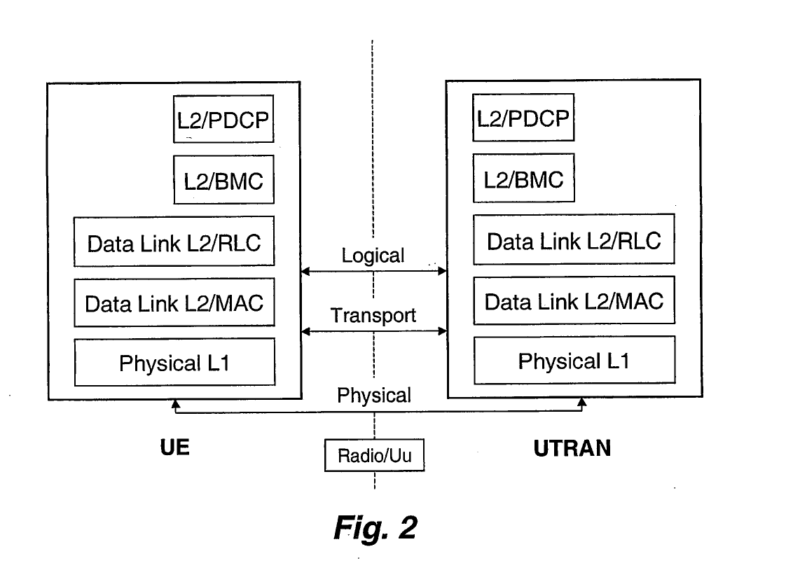

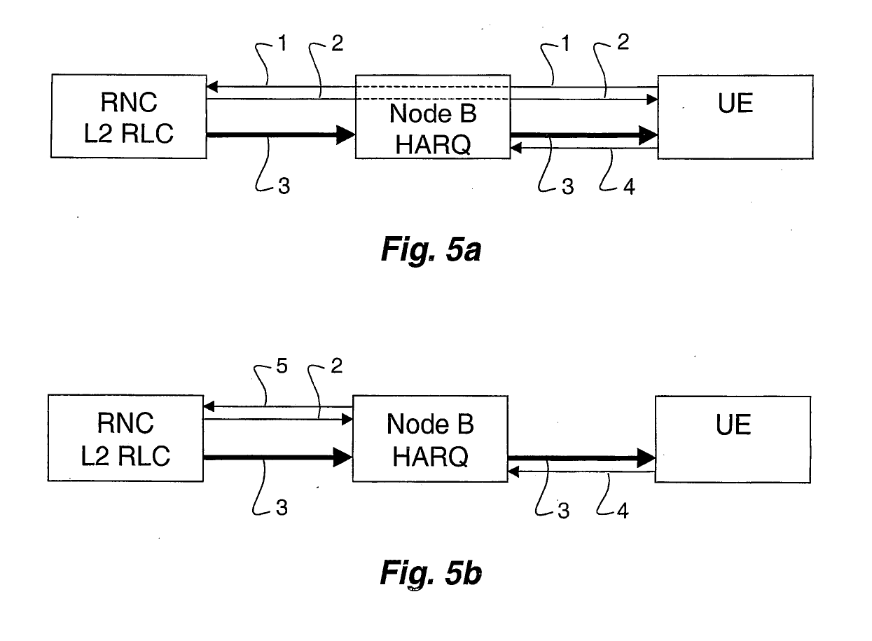

FIGS. 5a and 5b schematically illustrate the status report generation and transmissions, according to the invention. In FIG. 5a, L2 RLC located in RNC transfers data to UE via Node B, as already described in relation to FIG. 2. Downlink data 3 and requests for status reports 2 are transferred 2, 3 to UE via Node B. UE can also generate status reports when properly triggered locally. Status reports 1 are transmitted from UE to RNC, as described in relation to cited prior art.

In FIG. 5a, the Hybrid ARQ protocol resides in Node B. Downlink data is transmitted 3 over the radio interface between Node B and UE. Depending on whether the data transmission was successful or not, acknowledgements are transmitted 4 to Node B from UE. Status reports are generated in UE if data packets are missing, or detected to be out of sequence and transmitted 1, 4 to Node B. Status reports can also be transmitted 4 from UE upon request from Node B. In the sequel acknowledgements and status reports, and possibly other signaling related to Fast Hybrid ARQ, from UE to Node B are collectively referred to as HARQ signaling 4. Consequently, Node B has a good picture of the UE status as regards data packets transmitted to UE from RNC via Node B. This status includes
BVT(S) Node B Send state variable, and
BVT(A) Node B Acknowledge state variable.

BVT(S) is the sequence number of the next PU to be transmitted for the first time (i.e. excluding retransmission) from Node B. BVT(A) is the sequence number of the next in-sequence PU expected to be acknowledged by UE. BVT(A) forms the lower edge of the window of acceptable acknowledgements.

FIG. 5b shows a preferred solution according to the invention, where UE status in accordance with transmitted downlink data 3 and HARQ signaling 4 is stored in the HARQ protocol entity, preferably a MAC-HSDPA protocol.

When UE might locally generate status reports according to one or more predefined triggers, the one or more status reports are transferred 4 to Node B. Upon reception in Node B, this Node decides whether or not a received status report concerns also L2 RLC protocol layer. If so, the status report, possibly edited by Node B, is transferred 5 to L2 RLC residing in RNC. If not, Node B will undertake all actions necessary, in accordance with the status report.

An example of a UE-generated status report concerning the L2 RLC protocol of RNC is when UE-HARQ protocol, preferably in the MAC-HSDPA protocol link layer, detects a failure in UE, possibly due to a previously transmitted acknowledgment received in error by Node B. Upon detection of this failure, an RLC PDU will not be transferred from L2 MAC sub-layer to L2 RLC sub-layer of UE, as only presumably correct PDUs are transferred. When L2 RLC sub-layer of UE detects a missing RLC PDU, the sequence number of the missing RLC PDU will be included in a status report, generated by UE, and requested for retransmission from L2 RLC residing in RNC. Swedish patent application No. 0100739-2 assigned to the Applicant, and incorporated herein by reference, describes a method and system of retransmission, reducing or eliminating unnecessary retransmissions. This method and system can also be applied with the present invention, further reducing the load on the radio interface.

When L2 RLC, residing in RNC, sends a request for status report to UE, the request is first received in Node B, in both FIGS. 5a and 5b. In FIG. 5a, the request for status report is forwarded 2 to UE by default. Consequently, the requests and their responses load the radio interface between Node B and UE. Between Node B and UE, signaling and packet transfer are indicated by double arrows, 1 and 4 for uplink, and 2 and 3 for downlink, due to their logical differences. However, there is only one physical radio spectrum available with a limited channel capacity in each direction. Therefore, when the HARQ protocol entity or Node B is made responsible for status report generation and replies to L2 RLC requests for status reports, as in FIG. 5b, the load on the radio interface can be relieved. Hence, the elimination of arrows 1 and 2 between Node B and UE in FIG. 5b is not absolute. Depending on triggers selected, potential protocol failure etc. some signaling or packet transfer illustrated by the arrows in FIG. 5a may remain. However, the lack of these arrows in FIG. 5b illustrates that a substantial amount of the load can be eliminated according to the invention. In the foregoing, it was explained for various status report triggers, not limiting the invention only to this or other particular examples, how the invention can reduce the load of a scarce communication link resource in downlink, in uplink, or both.

There is a sender-receiver relationship between <<RNC>> and <<UE>>, in accordance with prior art. Packets transmitted from RLC protocol entity residing in RNC are acknowledged by User Equipment <<UE>>. The sender-receiver relationship is subject to latency due to a round-trip delay between <<RNC>> and <<UE>>, not illustrated to simplify reading.

A first problem of prior art solution relates to bandwidth delay product. HS-DSCH provide high data rate, also referred to as great user bandwidth. A transmitted packet cannot be acknowledged (positively or negatively) until it has propagated to a receiver. Further, it takes a propagation time for an acknowledgement to reach from the receiver to a sender of the packet. Consequently, data that may be requested for retransmission require buffering corresponding to the bandwidth delay product, representing the amount of data that can be transmitted during a time span equivalent to the round-trip time latency. Particularly, for HS-DSCH this bandwidth delay product can be extensive for an ARQ protocol entity in RNC. This can cause RLC PDU loss, or RLC ARQ or HARQ transmissions to stall.

Of course, these shortcomings could be circumvented by increasing buffer size as only measure. However, increasing a buffer size allowing for an extended round-trip time, would necessitate time-out timers of outer ARQ loops to be increased. Further, an extended variability of buffer lengths of the inner loop could be expected, depending on the various rates and delays of a connection during its lifetime. If relying on increased buffer size only, the time-out timers of outer ARQ loops must not time out until the largest round-trip time allowed for has elapsed.

In UMTS, existing RLC protocol operates with limited buffer sizes. One reason for this is delay constraints.

The problem of prior art, as explained above, cannot be solved by increasing RLC buffer size, as long as the RLC buffer is part of an end-to-end-delay of a connection between a data provider and an end user, where the data provider awaits acknowledgements from the user, since increasing RLC buffer size would introduce additional delay and require extensive time-out limits.

As a user moves with his user equipment away from a base station <<BS 1>> towards another base station <<BS 2>> in FIG. 1, the connection between UE and RNC is likely to be rerouted from being over a first Node B <<Node B 1>> to being over a second Node B <<Node B 2>> or over both <<Node B 1>> and <<Node B 2>> using soft handover. In FIG. 1, the base stations are connected to the same radio network controller RNC. However, the invention also covers the exemplary situation where the base stations are connected to different RNCs.

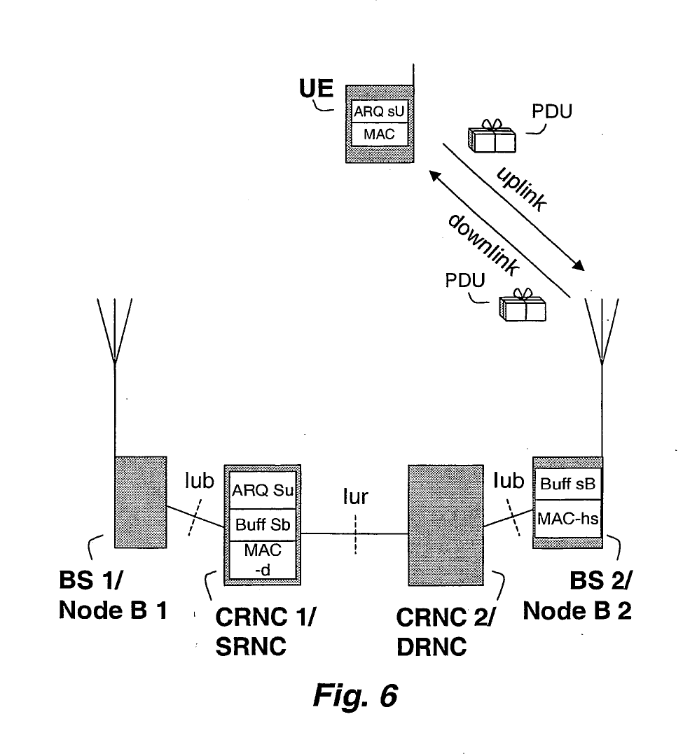

FIG. 6 illustrates an exemplary communications system with ARQ functionality located to RNC. The UE protocol <<MAC>> preferably also includes a MAC-HSDPA protocol, not indicated to simplify reading. In UTRAN, location of MAC-HSDPA protocol <<MAC-hs>> to Node B is preferred, as explained in relation to FIG. 3. Serving RNC <<SRNC>> interconnects UE to a Core Network, not illustrated. <<UE>> is connected to <<SRNC>> over <<Node B 2>> and <<CRNC 2/DRNC>>. According to FIG. 6, >>SRNC>> is not controlling the Node B <<Node B 2>>. (For illustration, <<SRNC>> controls <<Node B 1>>.) <<Node B 2>> is controlled by Controlling RNC <<CRNC 2>>, acting as a Drift RNC <<DRNC>> in this exemplary illustration. The Drift RNC supports the Serving RNC when a UE needs to use cells/Nodes B controlled by an RNC different from the SRNC. The RNCs are interconnected over an Iur interface. Routing of dedicated channels over common or shared channels comprises buffering of data in Serving RNC and Node B. In FIG. 6, the buffering occurs in buffers <<Buffer Sb>> and <<Buffer sB>> for the sender-receiver relationship between SRNC and Node B. The latency of the loop involving the buffers <<Buffer Sb>> and <<Buffer sB>> will be substantial if the distance between Serving RNC and Node B is large. In FIG. 6, there is further buffering <<ARQ Su>> in <<SRNC>> associated with the ARQ-protocol in the sender-receiver relationship between <<SRNC>> and <<UE>>. <<UE>> includes corresponding ARQ buffering <<ARQ Su>>.

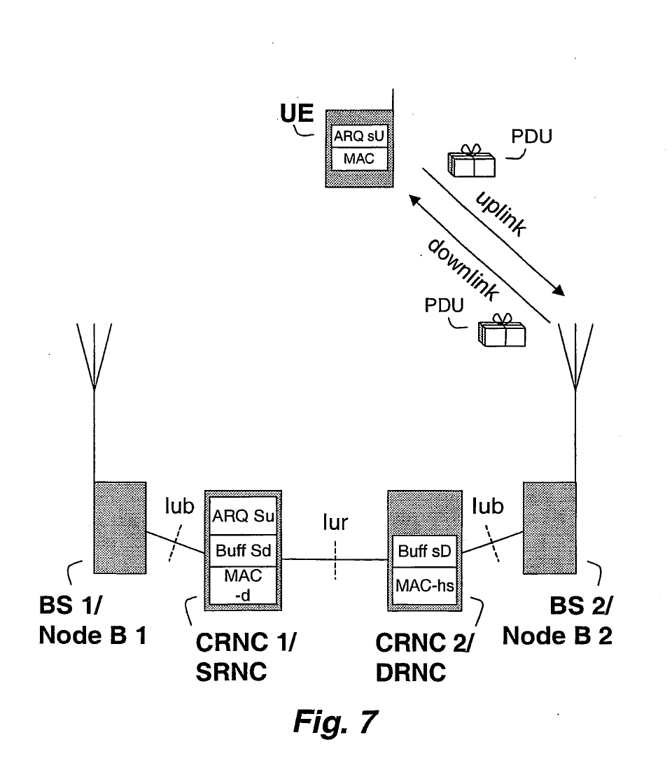

FIG. 7 illustrates an alternative exemplary communications system with ARQ functionality located to RNC. The figure represents alternatives for the MAC-protocol in RNC, including MAC-HSDPA protocol. However, location of MAC-HSDPA protocol <<MAC-hs>> to Node B is preferred. The UE protocol <<MAC>> preferably also includes a MAC-HSDPA protocol, not explicitly indicated in the figure to simplify reading. Serving RNC <<SRNC>> interconnects UE to a Core Network, not illustrated. <<UE>> is connected to <<SRNC>> over <<Node B 2>> and <<CRNC 2/DRNC>>. According to FIG. 7 <<SRNC>> is not controlling the Node B <<Node B 2>>. (For illustration, <<SRNC>> controls <<Node B 1>>.) <<Node B 2>> is controlled by Controlling RNC <<CRNC 2>>, acting as a Drift RNC <<DRNC>> in this exemplary illustration. The Drift RNC supports the Serving RNC when a UE needs to use cells/Nodes B controlled by an RNC different from the SRNC. The RNCs are interconnected over an Iur interface. Routing of dedicated channels over common or shared channels comprises buffering of data between Serving RNC and Controlling RNC. In FIG. 7, the buffering occurs in buffers <<Buffer Sd>> and <<Buffer sD>> for the sender-receiver relationship between SRNC and DRNC. The latency of the loop involving the buffers <<Buffer Sd>> and <<Buffer sD>> will be substantial if the distance between Serving RNC and Controlling RNC is large. In FIG. 7, there is further buffering <<ARQ Su>> in <<SRNC>> associated with the ARQ-protocol in the sender-receiver relationship between <<SRNC>> and <<UE>>. <<UE>> includes corresponding ARQ buffering <<ARQ Su>>.

Terminating RLC AM ARQ in Node B benefits from a round-trip time being constant for a particular Node B. This will simplify setting of time-out timers, reducing the round-trip time variability of RLC AM ARQ and outer ARQ loops. The inner HARQ loop RTT is kept at a low level using soft combining of successive retransmissions and due to shorter delay times between Node B and UE than between RNC and UE. The RLC entity in Node B should send an appropriate RLC status message to the Serving RNC when it discovers a missing RLC PDU or when a Poll flag, indicating that a status report is requested, is set by RNC RLC. This poll flag should be cleared prior to passing RLC PDUs further to HARQ transmitter unit to avoid triggering of status report transmissions from UE RLC.

Channels can be switched for several reasons. One example of channel switching is handover from one base station to another as a user moves. Another reason can be some channels being subject to heavy interference whereas others are not. By use of different channelization codes in WCDMA, users are allocated channels of different data rates. Other wireless systems, such as W-LANs (Wireless Local Area Networks) generally do not provide for handover from one base station to another including channel switching even if they allow for quasi-stationary connections to different base stations of the systems.

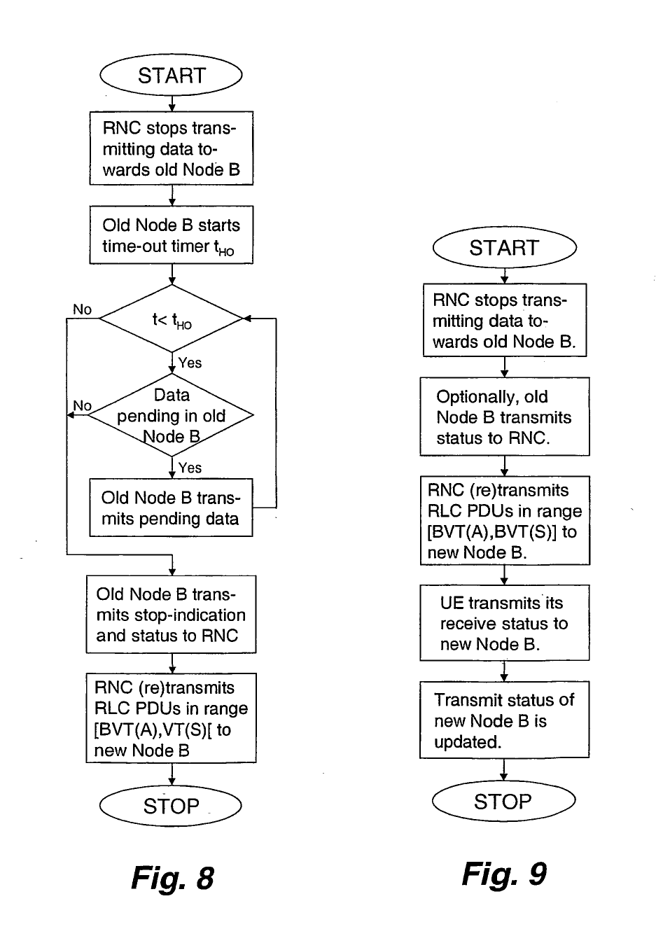

According to a first embodiment of the invention, schematically illustrated in FIG. 8, RLC Acknowledged Mode ARQ, RLC AM ARQ, is at least partly terminated in Node B and RLC state variables transferred and updated at handover and channel switching. RLC AM ARQ also retransmits data packets to Node B at data packet losses in Iub or Iur interface. At an HSDPA handover from an old Node B to a new Node B, the serving RNC stops data transmissions to the old Node B. The old Node B finishes its pending data transmissions during a predefined maximum time-period. When pending data has been transmitted or if the maximum time-period has elapsed, it transmits a stop-indication to the serving RNC. The stop-indication is accompanied by a latest Node B status of old Node B, including the next in-sequence PU expected to be acknowledged by UE, referred to as BVT(A).

When the serving RNC receives this indication it marks all its RLC PDUs within a frame of PU sequence numbers ranging from BVT(A) to VT(S) as negatively acknowledged, and scheduling these RLC PDUs for retransmission to the new Node B, via the RNC controlling new Node B.

Substituting controlling RNC for Node B, FIG. 8 is also valid for an implementation with MAC-HSDPA in controlling RNC, as in FIG. 7. The serving RNC then schedules data packets, interpreted as negatively acknowledged RLC PDUS, for retransmission to new controlling RNC at an inter-RNC handover.

According to a second embodiment schematically depicted in FIG. 9, at HSDPA handover data queues of new Node B are updated from UE, i.e. over Uu interface. Preferably, the entire transmitter window of PU sequence numbers ranging from BVT(A) to BVT(S) of old Node B is transferred to new Node B, where BVT(S) denotes the sequence number of the next PU scheduled for transmission for the first time from old Node B. This transmitter window is transmitted as soon as possible, without RNC awaiting a stop-indication from old Node B. As Node B regularly transfers status reports to RNC RLC, the transmitter window from the latest update may already be available to RNC and can be transferred to new Node B without further status transfer between Node B and RNC.

As soon as UE receives a handover command, it includes additional control information to its uplink HS-DSCH control messages. This control information includes the receive state variable VR(R). If UE has multiple logical channels on the HS-DSCH, there is one receive state variable for each logical channel.

New Node B will receive this control information from UE, while still being in stand-by mode. The one or more receive state variables are used for updating the transmitter window of new Node B, the transmitter initially set in accordance with old Node B transmitter window. This updating has to be completed prior to new Node B starting its transmissions of PDUs and transport blocks to UE, to maintain in-sequence delivery of RLC PDUs to UE.

Also FIG. 9 is valid for an implementation with MAC-HSDPA in controlling RNC, substituting controlling RNC for Node B. The serving RNC then schedules RLC PDUs interpreted as negatively acknowledged for retransmission to new controlling RNC for an inter-RNC handover and UE updates status of controlling RNC via Node B.

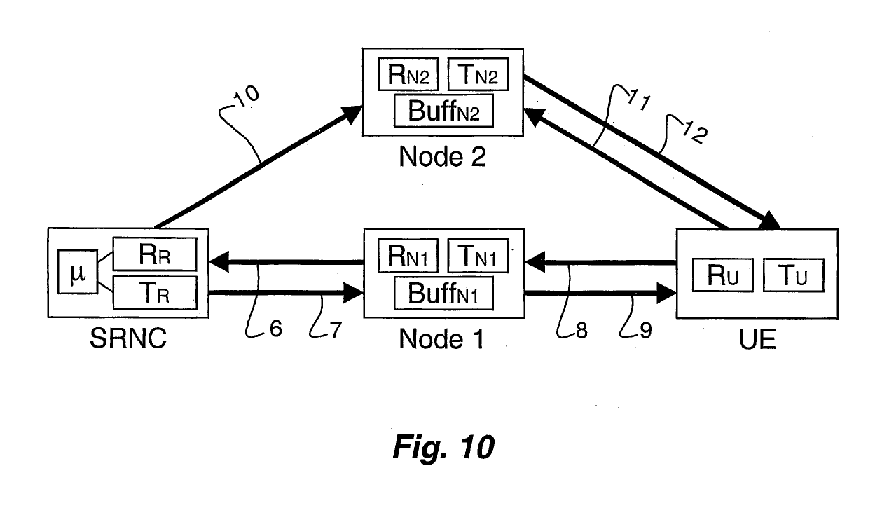

FIG. 10 shows a block diagram including elements of the first and second embodiments. A serving RNC <<SRNC>> including receive means <<R_{R}>>, processing means <<μ>> and transmit means <<T_{R}>>. Transmit means <<T_{R}>> transmits data 7 from a transmitter window comprising data packets with sequence numbers in the range of VT(A) to VT(S) to a node <<Node 1>> comprising a MAC-HSDPA protocol, preferably <<Node 1>> is a Node B, but it can also be a controlling RNC. Data packets received by receive means <<R_{N1}>> in <<Node 1>>, also comprising transmit means <<T_{N1}>>, are buffered in buffer <<Buff_{N1}>> for transmission 9 to user equipment <<UE>> including receive means <<R_{U}>>. At handover from a channel associated with <<Node 1>> to a channel associated with <<Node 2>>, <<Node 1>> transmits as much of its buffer content in <<Buff_{N1}>> as allowed to user equipment <<UE>>. <<Node 1>> with receive means <<R_{N1}>> receives acknowledgements 9 of successfully transmitted packets to <<UE>>. The sequence number of the next data packet expected to be acknowledged, BVT(A), is transmitted 6 to <<SRNC>> together with a stop-indication, according to the first embodiment of the invention. The status variable BVT(A) and the stop-indication are received by receive means <<R_{R}>> of <<SRNC>>. Processing means <<μ>> interprets data packets with sequence numbers in the range [BVT(A), VT(S)[ as negatively acknowledged and (re)transmits 10 these data packets to the new node <<Node 2>>, where they are received by receive means <<R_{N2}>> and buffered in <<Buff_{N2}>>.

According to the second embodiment there is no need for transmission of a stop-indication and time for emptying the buffer <<Buff_{N1}>>. Old node <<Node 1>> transmits 6 its status variables BVT(A) and BVT(S) at the time of handover to <<SRNC>>. Processing means <<μ>> interprets the data packets in the range as negatively acknowledged and retransmits 10 the data packets to new node <<Node 2>>. Prior to new node <<Node 2>>, with transmit means <<T_{N2}>>, starts data transmissions 12 to user equipment <<UE>>, having transmit means <<T_{U}>> and receive means <<R_{U}>>, it updates its transmit buffer <<Buff_{N2}>> according to current receive status VR(R) of <<UE>> as received 12.

Preferably, all retransmission entities, interconnecting networks or channels of different characteristics, e.g. RNCs and Nodes B in UMTS, operate according to the invention for outstanding performance. However, the invention can also be used in systems also including retransmission entities, such as Nodes B, not operating according to the invention.

A person skilled in the art readily understands that the receiver and transmitter properties of a BS or a UE are general in nature. The use of concepts such as BS, UE or RNC within this patent application is not intended to limit the invention only to devices associated with these acronyms. It concerns all devices operating correspondingly, or being obvious to adapt thereto by a person skilled in the art, in relation to the invention. As an explicit non-exclusive example the invention relates to mobile stations without a subscriber identity module, SIM, as well as user equipment including one or more SIMs. Further, protocols and layers are referred to in close relation with UMTS and Internet terminology. However, this does not exclude applicability of the invention in other systems with other protocols and layers of similar functionality. As a non-exclusive example, the invention applies for radio resource management interfacing of a connection protocol application layer as well as interfacing of a connection protocol transport layer, such as TCP.

The invention is not intended to be limited only to the embodiments described in detail above. Changes and modifications may be made without departing from the invention. It covers all modifications within the scope of the following claims.

1. A method of retransmitting packet units in a communications system, said method comprising the steps of:
providing a retransmission loop between a sending entity and a receiving entity, said retransmission loop including two or more concatenated retransmission sub-loops, comprising a first transmitter, a second transmitters, and a receiver; and
transferring signaling from the second transmitter to the first transmitter, the signaling carrying a status variable indicating a next in-sequence number of a packet unit expected to be acknowledged by the receiving entity, the signaling being transferred in association with handover.

2. The method according to claim 1 characterized in that the signaling carrying the status variable is transferred at handover of a channel between the second transmitter and the receiving entity.

3. The method according to claim 1, wherein the second transmitter sends a stop-indication accompanying the status variable to the first transmitter.

4. The method according to claim 1, wherein the second transmitter sends a stop-indication when there are no more data packets for the receiving entity pending at the second transmitter, or a time-out timer has elapsed.

5. The method according to claim 1, wherein one or more data packets to be sent to the receiving entity, that are pending at the second transmitter, are transmitted to the receiving entity prior to transferring the signaling carrying the status variable.

6. The method according to claim 1, wherein the signaling carrying the status variable is not transferred until there are no more data packets for the receiving entity pending at the second transmitter, or a time-out timer has elapsed.

7. The method according to claim 1, wherein the first transmitter interprets the status variable as a negative acknowledgement of packet units ranging from the next in-sequence number of packet unit expected to be acknowledged by the receiving entity to the second transmitter up to the sequence number of the next packet unit to be transmitted for the first time from the first transmitter to the second transmitter.

8. The method according to claim 7 wherein packet units considered negatively acknowledged are transmitted to a third transmitter.

9. The method according to claim 1 wherein the second transmitter transfers signaling carrying a status variable indicating sequence number of next packet unit to be transmitted for the first time from the second transmitter.

10. The method according to claim 9 wherein the signaling carrying the status variables is transferred at handover of a channel between the second transmitter and the receiving entity.

11. The method according to claim 9 wherein the first transmitter interprets the status variables as a negative acknowledgement of packet units ranging from the next in-sequence number of packet unit expected to be acknowledged by the receiving entity to the second transmitter up to the sequence number of the next packet unit to be transmitted for the first time from the second transmitter to the receiving entity.

12. The method according to claim 9, wherein packet units considered negatively acknowledged are transmitted to a third transmitter.

13. The method according to claim 9, wherein the receiving entity transmits one or more signals carrying its receive status to a third transmitter.

14. The method according to claim 9, wherein a third transmitter updates its transmit status according to the receive status of the receiving entity.

15. The method according to claim 9, wherein the receive status includes the sequence number of the next in-sequence PU expected to be received.

16. The method according to claim 1, wherein a connection is handed over from a channel between the second transmitter and the receiving entity to a channel between a third transmitter and the receiver

17. The method according to claim 2, wherein the channel is a High Speed Downlink Packet Access (HSDPA) channel or a High Speed Downlink Shared Channel (HS-DSCH).

18. The method according to claim 12, wherein the third transmitter is a radio network controller, a Node B, or a base station.

19. The method according to claim 1, wherein the second transmitter is a radio network controller, a Node B, or a base station.

20. The method according to claim 1, wherein the first transmitter is a radio network controller.

21. The method according to claim 1, wherein the receiving entity is a user equipment.

22. The method according to claim 1, wherein the communications system is a universal mobile telecommunications system or a Wideband Code Division Multiple Access (WCDMA) system.

23. A network element for retransmitting packet units in a communications system, said network element comprising:
a retransmission loop between a sender and a receiver, said retransmission loop comprising two or more concatenated retransmission sub-loops, the retransmission loop comprising:
a first transmitters;
a second transmitter; and
receive means for receiving signaling carrying a status variable from the second transmitter, the status variable indicating a next in-sequence number of a packet unit expected to be acknowledged by the receiver, the signaling being transferred in association with handover.

24. The network element according to claim 23, wherein the receive means receives a stop-indication accompanying the status variable.

25. The network element according to claim 23, further comprising processing means for interpreting reception of the status variable as a negative acknowledgement of packet units ranging from the sequence number indicated by the status variable up to the sequence number of the next packet unit to be transmitted for the first time from network element to the second transmitter.

26. The network element according to claim 23, wherein the receive means receives signaling carrying a status variable from a second transmitter, the status variable indicating the sequence number of the next packet unit to be transmitted for the first time from the second transmitter.

27. The network element according to claim 26, further comprising processing means for interpreting reception of the status variables as a negative acknowledgement of packet units within a range as indicated by the status variables.

28. The network element according to claim 25, wherein the signaling carrying the status variable is transferred at handover of a channel between the second transmitter and the receiver.

29. The network element according to claim 23, further comprising transmit means for transmitting packet units considered negatively acknowledged to a third transmitter.

30. The network element according to claim 29, wherein the third transmitter is, or is included in, a radio network controller, a Node B, or a base station.

31. The network element according to claim 23, wherein the communications system is a universal mobile telecommunications system or a Wideband Code Division Multiple Access (WCDMA) system.

32. A network element for retransmitting packet units in a communications system, said network element comprising:
a retransmission loop between a sender and a receiver, said retransmission loop comprising two or more concatenated retransmission sub-loops, the retransmission loop comprising:
a first transmitter;
a second transmitter; and
transmit means for transferring signaling to the first transmitter, said signaling carrying a status variable indicating a next in-sequence number of a packet unit expected to be acknowledged by the receiver, the signaling being transferred in association with handover.

33. The network element according to claim 32 wherein the signaling carrying the status variable is transferred at handover of a channel between the second transmitter and the receiver.

34. The network element according to claim 32, further comprising transmit means for sending a stop-indication accompanying the status variable to the first transmitter.

35. The network element according to claim 32, wherein the second transmitter sends a stop-indication when there are no more data packets for the receiver pending at the second transmitter, or a time-out timer has elapsed.

36. The network element according to claim 32, further comprising a packet data transmit buffer.

37. The network element according to claim 32, wherein one or more data packets to be sent to the receiver, that are pending at the second transmitter, are transmitted to the receiver prior to transferring the signaling carrying the status variable.

38. The network element according to claim 32, wherein the signaling carrying the status variable is not transferred until there are no more data packets for the receiver pending at the second transmitter, or a time-out timer has elapsed.

39. The network element according to claim 32, further comprising transmit means for transferring signaling carrying a status variable indicating the sequence number of the next packet unit to be transmitted for the first time from the second transmitter.

40. The network element according to claim 39, wherein the signaling carrying the status variables is transferred at handover of a channel between the network element and the receiver.

41. The network element according to claim 32, further comprising receive means for receiving signaling carrying receiver receive status.

42. The network element according to claim 32, further comprising circuitry for updating the network element transmit status according to the receive status of the receiver.

43. The network element according to claim 42, wherein the receive status includes the sequence number of the next in-sequence packet unit expected to be received.

44. The network element according to claim 32, wherein the network element is involved in a handover of a channel between the network element and the receiver.

45. The network element according to claim 44, wherein the channel is a High Speed Downlink Packet Access (HSDPA) channel or a High Speed Downlink Shared Channel (HS-DSCH).

46. The network element according to claim 32, wherein the first transmitter is, or is included in, a radio network controller.

47. The network element according to claim 32, wherein the second transmitter is, or is included in, a radio network controller.

48. The network element according to claim 32, wherein the network element is a radio network controller, a Node B, or a base station.

49. The network element according to claim 32, wherein the communications system is a universal mobile telecommunications system (UMTS) or a Wideband Code Division Multiple Access (WCDMA) system.

50. A receiving device for receiving transmissions and retransmissions of packet units on a communications channel in a communications system, wherein a retransmission loop between a sender and the receiving device includes two or more concatenated retransmission sub-loops, the receiving device comprising:
means for determining a receive status; and
transmit means for transferring one or more signals carrying the receive status to a network element, the one or more signals being transferred in association with handover.

51. The receiving device according to claim 50, wherein the receive status is transmitted for updating of the network element transmit status.

52. The receiving device according to claim 50, further comprising transmit means for transmitting the receive status to the network element at handover.

53. The receiving device according to claim 50, wherein the receive status is transmitted prior to the receiving device receiving any transmissions from the network element.

54. The receiving device according to claim 50, wherein the receive status includes the sequence number of the next in-sequence packet unit expected to be received.

55. The receiving device according to claim 50, wherein the communications channel is a High Speed Downlink Packet Access (HSDPA) channel or a High Speed Downlink Shared Channel (HS-DSCH).

56. The receiving device according to claim 50, wherein the communications system is a universal mobile telecommunications system (UMTS) or a Wideband Code Division Multiple Access (WCDMA) system.

57. The receiving device according to claim 50, wherein the receiving device is a user equipment.

58. The receiving device according to claim 50, wherein the network element is a radio network controller, a Node B, or a base station.

59-61. (Canceled)
